(19) United States
(12) Patent Application Publication
(10) Pub. No.: US 2011/0173589 A1
(43) Pub. Date: Jul. 14, 2011

(54) Cross-Browser Interactivity Testing

(75) Inventors: Steve Guttman, Mercer Island, WA (US); Michael Fanning, Redmond, WA (US); Matt Hall, Seattle, WA (US)

(73) Assignee: MICROSOFT CORPORATION, Redmond, WA (US)

(21) Appl. No.: 12/686,436

(22) Filed: Jan. 13, 2010

(51) Int. Cl. G06F 3/01; G06F 9/44

(52) U.S. Cl. 717/125; 715/760

(57) ABSTRACT

Multi-browser interactivity testing connects a leader browser and one or more follower browsers. Direct user input to the follower browsers is blocked. User input to the leader browser directed at a Document Object Model element is intercepted. A corresponding element is located in each follower browser, using attribute values or other mechanisms. The user input is applied to the leader element, and applied to the follower element(s) by simulated system level events, and the results are displayed in real time on all browsers. Layout which depends on interactive behaviors such as login or accordion controls, and other aspects of interactivity can be tested without manually repeating the input for each browser, and despite differences in the screen territories assigned to an element by different browser's layout engines. The leader and follower browser roles can also be interchanged automatically.

### BACKGROUND

Browsers are perhaps most familiar as tools for retrieving, presenting, and navigating web pages in the World Wide Web. Web pages may contain text, still images, video, audio, and interactive content. Browsers can also be used to access information provided by servers or peers in private networks, or in local files on a particular computer, smart phone, or other device.

A wide variety of browsers can be found in service. For example, different versions of Microsoft® Internet Explorer® browsers exist, with different capabilities (Internet Explorer® is a mark of Microsoft Corporation). Although the Internet Explorer® browser is widely used, many other browsers are also used, on computers, on phones, in cars, and in other devices. Browsers differ in characteristics such as the operating system(s) they run under, the layout engines they use to translate web page objects into visual displays, the mechanisms they use to accept user input, which features they implement natively (without plug-ins or other extensions), and which web standards and protocols they support, for example.

### SUMMARY

Browsers differ in how they render images, page layouts and generate page interactivity for users. To enhance or supplement technologies for testing screen layout in different browsers, some embodiments described herein support cross-browser interactivity testing. For instance, different browsers can be simultaneously and interactively tested to identify and explore differences in behavior based on JavaScript® code or Cascading Style Sheet code (JavaScript® is a mark of Sun Microsystems, Inc.).

Some embodiments support multi-browser interactivity testing. A leader browser and one or more follower browsers are designated. User input to the leader browser is intercepted and used to identify a pertinent leader element, namely, a Document Object Model (DOM) element in the leader browser which is configured to respond to the intercepted user input. Input can be intercepted using mechanisms such as transparent windows and/or event handlers. Direct user input to the follower browser(s) can also be disabled. A pertinent follower element, corresponding to the pertinent leader element, is located in each follower browser. The user input is applied to the pertinent leader element, and to the pertinent follower element, and the results are displayed in real time, side-by-side on a single screen or otherwise. The pertinent follower element can be located through mechanisms such as an element ID attribute value, a DOM tree position, a predetermined set of element attribute values, and/or a position (such as a position with respect to a viewport origin). The user input can be applied to the pertinent follower element by generating a system level event in the follower browser despite the absence of direct user input to the follower browser, or by invoking on the pertinent follower element a method defined in an enhanced DOM tree, for example.

Some embodiments freeze browser state to facilitate interrogation of page layout and of DOM element attribute values. Some embodiments record interactions between a user and the leader browser, and some transmit those recordings to remote follower browsers to have user inputs applied remotely.

The leader browser and one (or more) follower browsers may reside on the same device or on different devices. The devices bearing browsers may be workstation devices, portable devices, embedded devices, and/or phone devices, for example. In some embodiments, the roles of leader and follower may be interchanged automatically.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer or other device having at least one processor, at least one memory, at least one browser, and other items in an operating environment which may be present on multiple network nodes, and also illustrating configured storage medium embodiments;

FIG. 2 is a block diagram illustrating a leader browser, follower browser(s), interactivity testing code, and other components in an example architecture for some embodiments;

FIG. 3 is a block diagram illustrating mechanisms for intercepting user input, applying user input, and/or otherwise managing user input in some embodiments;

FIG. 4 is a diagram representing a screen having one region allocated to a leader browser and another region allocated to a follower browser during interactivity testing in some embodiments;

FIG. 5 is a block diagram illustrating an embodiment in which a leader browser resides on one device, and three follower browsers reside respectively on three other devices, with the devices connected by a network;

FIG. 6 is a block diagram illustrating normalized records of user-browser interaction in some embodiments;

FIG. 7 is a flow chart illustrating steps of some method and configured storage medium embodiments; and

FIG. 8 is a data flow diagram illustrating some embodiments.

### DETAILED DESCRIPTION

Overview

During the development of web pages, significant effort may be spent to ensure that web pages will function similarly in a wide variety of browsers, including for example multiple versions of Microsoft Internet Explorer® software, Firefox® software, and Safari® software (marks of Microsoft Corporation, Mozilla Foundation, and Apple, Inc., respectively). While several solutions exist for statically testing whether the layout of elements on a page match in different browsers, solutions for testing cross-browser interactivity such as JavaScript® code behaviors and animations, as well as Cascading Style Sheet (CSS) code behaviors, have been lacking.

One may divide familiar solutions to cross-browser layout into two groups. One group includes layout solutions such as the Adobe® BrowserLab service and the Microsoft® Expression Web SuperPreview tool. These solutions allow a user to verify the layout of page elements in multiple browsers by essentially taking pictures of pages and allowing users to compare those pictures and identify which elements are the same (or different) in order to help diagnose why they are different. In this group, the solutions provide static pictures, possibly supplemented by element information. Interactive behaviors are not adequately explored, if at all, by such solutions.

A second group includes layout solutions such as the IETester tool. These solutions merely host multiple browsers in a side-by-side fashion, allowing a user to test a sequence of operations in one browser, and then conveniently switch to another browser to test the same sequence. The IETester tool allows developers to access multiple, incompatible versions of Internet Explorer® software. However, this second group of layout software does not provide the ability to simultaneously test multiple browsers.

Another known technology is “co-browsing” whereby users install a special client (usually a browser plug-in) on their machines. Browsers are placed in a master-slave relationship during co-browsing, such that a slave browser will automatically go to a destination set in a master browser. However, co-browsing merely synchronizes web page destinations, not the user actions and page behaviors within a destination web page.

By contrast, some embodiments described herein support cross-browser interactivity testing, through cross-browser page visualization generation and cross-browser page visualization presentation, for example. Some embodiments provide a mechanism for simultaneously testing web page interactivity (animations, behaviors, programmatic response) in multiple web browsers. A user interacts directly with a leader (baseline) browser, and the interactions (clicks, mouse-overs and other gestures) with page elements are mapped to the corresponding page elements in follower browsers. Follower browsers can be located on the same machine and even hosted within the same interface as the leader browser, or followers can be located on different physical CPUs than the leader. In some configurations, one or more followers are on the same machine as the leader, and other followers of that same leader are on different machine(s).

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes constants, variables, and data structures), or both instructions and data.

“Automatically” means by use of automation (e.g., general purpose computing hardware configured by software for specific operations discussed herein), as opposed to without automation. In particular, steps performed “automatically” are not performed by hand on paper or in a person's mind; they are performed with a machine.

Throughout this document, use of the optional plural “(s)” means that one or more of the indicated feature is present. For example, “browser(s)” means “one or more browsers” or equivalently “at least one browser”.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

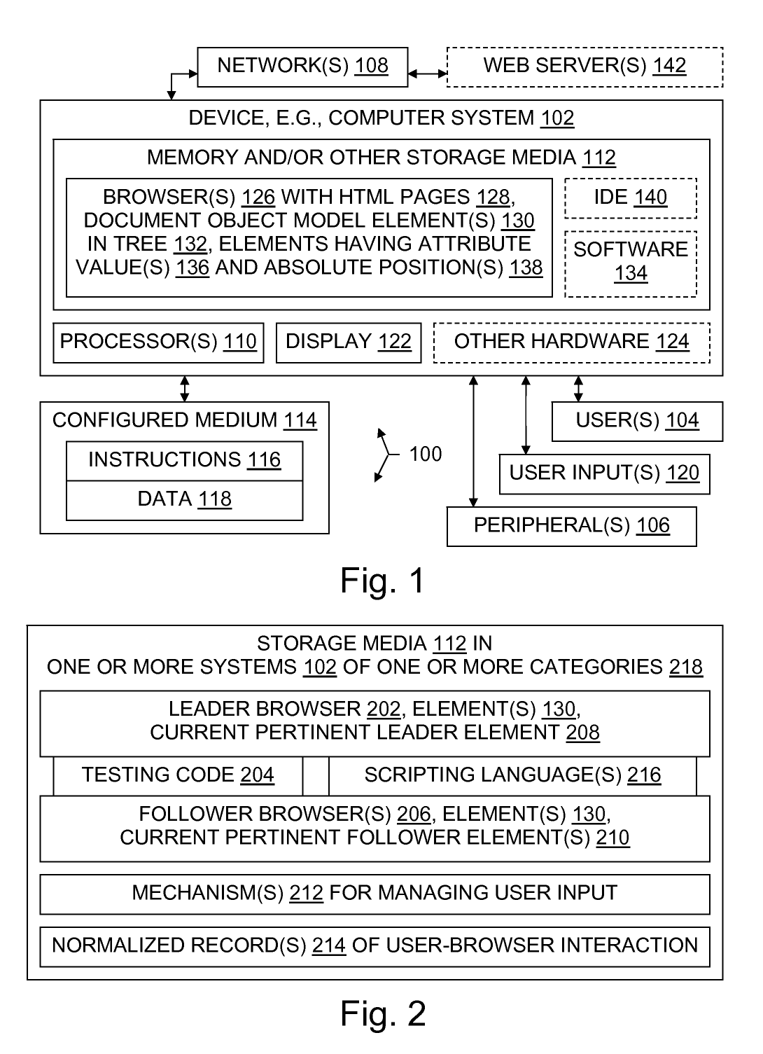

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked.

Human users 104 may interact with the computer system 102 by using displays, keyboards, and other peripherals 106, e.g., to request web pages 128 from web server(s) 142. System administrators, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example. During interactions, users provide input(s) 120 through keyboards, mice, and other peripherals 106, and/or through network 108 connection(s), and users receive output data through a display 122, other hardware 124, and/or network connection, for example.

The computer system 102 includes at least one logical processor 110. The computer system 102, like other suitable systems, also includes one or more computer-readable non-transitory storage media 112. The media 112 may be volatile memory, non-volatile memory, fixed in place media, removable media, magnetic media, optical media, and/or of other types of non-transitory media (as opposed to transitory media such as a wire that merely propagates a signal). Media 112 may be of different physical types. In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a computer-readable storage medium 112. Some other examples of computer-readable storage media 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the medium 114 in which they reside; when that memory is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed as discussed herein, e.g., by mapping, interception, execution, suspension, interrogation, modification, display, creation, loading, and/or other operations.

One or more web browsers 126 with HTML pages(s) 128 and corresponding Document Object Model (DOM) element(s) 130 in one or more DOM trees 132, other software 134, and other items shown in the Figures may reside partially or entirely within one or more media 112, thereby configuring those media. Elements 130, sometimes also referred to as objects, may have associated attribute value(s) 136. Displayable elements 130 generally have respective position(s) 138, such as position(s) relative to some viewport origin. In some cases, the position of an element depends on the width of the browser window, and the browser rendering engine, as well. In addition to processors 110, optional peripheral(s) 106, media 112, and an optional display 122, an operating environment may also include other hardware 124, such as buses, power supplies, and accelerators, for instance.

A given operating environment 100 may include an Integrated Development Environment (IDE) 140 which provides a developer with a set of coordinated software development tools. In particular, some of the suitable operating environments for some embodiments include or help create a Microsoft® Visual Studio® development environment (marks of Microsoft Corporation) configured to support program development. Some suitable operating environments include Java® environments (mark of Sun Microsystems, Inc.), and some include environments which utilize languages such as C++ or C# (“C-Sharp”), but teachings herein are applicable with a wide variety of programming languages, programming models, and programs, as well as with endeavors outside the field of software development per se that use browsers.

Some items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

Systems

FIG. 2 illustrates an architecture which is suitable for use with some embodiments. A leader browser 202 receives input which is mapped at the element 130 level by interactivity testing code 204 to provide corresponding interaction with one or more follower browsers 206. In particular, a pertinent leader element 208, which is an element 130 at which specified user input 120 is directed, is mapped to a corresponding pertinent follower element 210, and the user input is applied to the pertinent follower element(s) to test their interactive behavior under the guidance of simulations of the input directed at the leader browser. Mechanisms 212 for intercepting, blocking, applying, simulating, and otherwise managing user input are provided in various embodiments discussed herein.

Some embodiments create normalized records 214 of user interaction with the leader browser, and some embodiments control follower browser behavior by reading and acting upon these normalized records 214 of user-browser interaction.

In some embodiments, interactive behavior of scripting language 216 code (e.g., JavaScript® code) in web pages can be tested. A user directs a sequence of user inputs 120 at a leader browser, and the testing code 204 automatically maps those inputs through pertinent leader elements to pertinent follower elements. The testing code also automatically applies the inputs to the pertinent follower elements, so browser scripting language behavior and other behaviors can be tested simultaneously in multiple browsers on one or more machines, without requiring a user to repeat the input into each browser manually or with a test-scenario-specific script for each test sequence and each browser.

A given embodiment may include one or more systems 102 (a.k.a. devices, machines) of one or more types. For example, a system 102 may be viewed as belonging to one or more of the following device categories 218: workstation devices (e.g., desktop computers, server computers), portable devices (e.g., laptop computers), embedded devices (e.g., systems embedded in automotive, aerospace, marine, and other vehicles), and phone devices (e.g., sell phones, smart phones).

With reference to FIGS. 1 and 2, some embodiments provide a computer system 102 with a logical processor 110 and a memory medium 112 configured by circuitry, firmware, and/or software to transform input directed by a user at a leader browser into contemporaneous automatic element-level-corresponding simulated input in one or more follower browsers as described herein.

In some embodiments peripherals 106 such as human user I/O devices (screen, keyboard, mouse, tablet, microphone, speaker, motion sensor, etc.) will be present in operable communication with one or more processors 110 and memory. However, an embodiment may also be configured such that no human user 104 interacts directly with the embodiment; software processes may be users 104.

In some embodiments, the system includes multiple computers connected by a network. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

In some embodiments, a multi-browser interactivity testing system includes at least one logical processor 110, and at least one local memory in operable communication with a logical processor. A leader browser 202 having leader Document Object Model elements 130 resides in a local memory. A follower browser 206 having follower Document Object Model elements 130 resides in a local memory. Interactivity testing code 204 resides in at least one local memory. That is, the leader browser 202, follower browser(s) 206, and interactivity testing code 204 may reside in one or more memories, in operable communication with one or more logical processors 110; in this context, “local” implies in the same device as a logical processor, as opposed to being in some other device. Unless otherwise indicated, a reference to a logical processor in a claim means one or more logical processors is present.

The interactivity testing code 204 is configured to locate, among the follower Document Object Model elements, a pertinent follower element which corresponds to a pertinent leader element. The pertinent leader element is a leader Document Object Model element targeted by a user input to the leader browser. The interactivity testing code 204 is also configured to apply the user input to the pertinent follower element.

In some embodiments, for example, a portion of the interactivity testing code 204 resides with the leader browser on a first machine, another portion of the interactivity testing code 204 resides with a follower browser on a second machine, and a similar portion of the interactivity testing code 204 resides with another follower browser on a third machine. As with other systems 102, a particular machine could be a uniprocessor device or a multicore device.

More generally, one or more follower browsers may be present in a particular embodiment. In some embodiments, the leader browser, the follower browser, and the interactivity testing code all reside on the same device. In other embodiments, the leader browser resides on a first device having a first logical processor and a first local memory, the follower browser resides on a second device having a second logical processor and a second local memory, and at least a portion of the interactivity testing code resides on each of the devices. For example, some embodiments connect browser(s) on an Apple® Macintosh or other OS X operating system machine with browser(s) on a Microsoft Windows XP® or other Microsoft Windows operating system machine, such that the leader browser and at least one follower browser are running and being tested under different operating systems.

In some embodiments, device categories 218 include: workstation devices such as desktops and servers; portable devices such as laptops, tablets, and network computers; embedded devices such as those embedded in cars, planes, or other vehicles, or in appliances; and phone devices. A first device and a second device on which browsers are running can be of different device categories. The interactivity testing code is not necessarily implemented in every available device category; the categories used may vary between embodiments.

In some embodiments, one or more follower browsers are allowed. In some cases, though, the embodiment includes at least one additional pertinent follower element in at least one additional follower browser, and the interactivity testing code is configured to applying the user input to at least one of the additional pertinent follower element(s). In such embodiments, two or more follower browsers are present. For example, FIG. 5 illustrates an embodiment having three follower browsers communicating with a leader browser over a network.

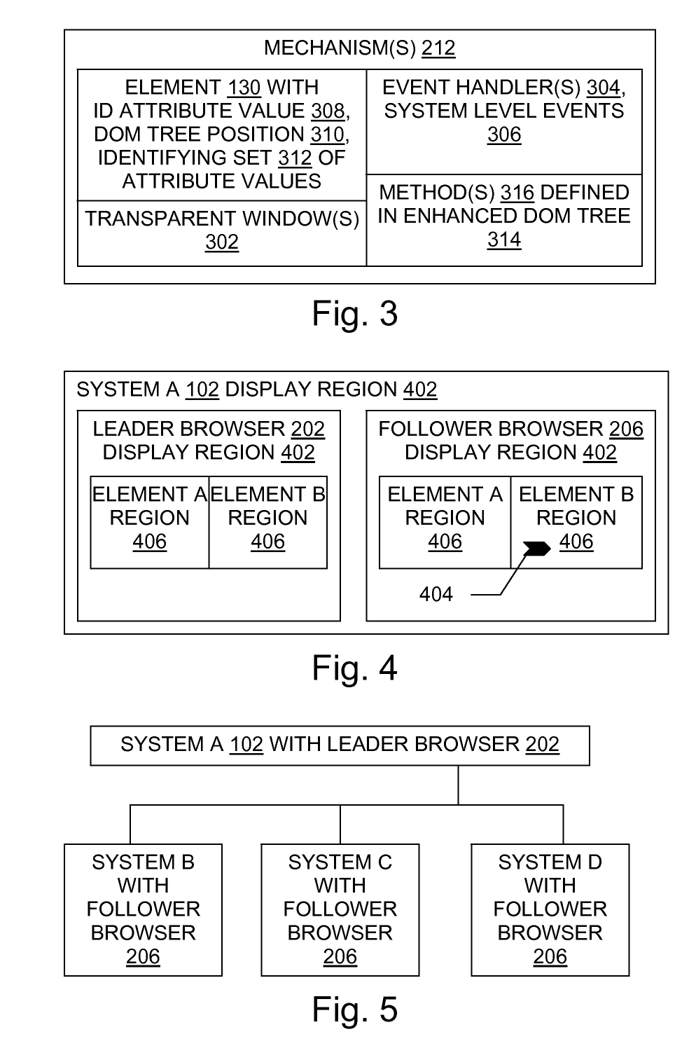

With regard to mechanisms 212 for managing user input, and with reference now to FIGS. 3 and 4 as well as FIGS. 1 and 2, some embodiments include a transparent window 302 positioned in front of a browser window or other display region 402. Using the transparent window, the interactivity testing code 204 intercepts signals from user input devices (peripherals 106), such as mouse, pen, and/or touch screens signals directed at the browser. Signals intercepted by a transparent window in front of a follower browser may be discarded or passed to a pertinent element after interactivity analysis. In some situations the follower browser is not controlled by live direct input (user→follower browser) but instead receives its input via the leader (user→leader browser→system signals→follower browsers). An attempt to control a follower browser directly, instead of controlling the follower browser via the leader browser, can be blocked by discarding the direct input to the follower browser. In some situations a follower browser accepts input both directly and indirectly. In some situations, a signal intercepted by a transparent window in front of a leader browser may be analyzed to identify the pertinent leader element 208 at which the signal was directed. In operation, some embodiments associate pertinent leader elements and pertinent follower elements by looking at the associated browser DOMs, which are not guaranteed to be identical. So one aspect of some embodiments is associating a leader DOM element with the identical follower element. Another method is to “hook” the window handle for the browser, which wouldn't require a transparent window. One would thus intercept all messages to the existing window at the Windows API level.

In some embodiments, an element 130 such as a pertinent leader element 208 and/or a pertinent follower element 210, is specified with an element ID attribute value 308. Element ID attribute values need not necessarily be present on elements that do not serve as pertinent elements. Not all pertinent elements are necessarily provided with ID attributes in every page 128, so a pertinent element may also be specified in some cases by other mechanisms.

In some embodiments, for example, the element may be specified by its position 310 in the DOM tree. Position may be specified by listing a path from the root to the element. For instance, “113” could mean “start at root, follow leftmost link, follow leftmost link, follow third link from left, to arrive at element”. Position may also be specified by listing the ordinal of the element in a particular traversal. For instance, “17” could mean “the element is the seventeenth element in a pre-order traversal starting at the root”.

In some embodiments, the element may be specified by a particular set 312 of attribute values 136. For instance, the pertinent element may be the only element in the tree 132 which has both a Flashing_On attribute value and a Fuzzy_Border attribute value.

In some embodiments, an event handler 304 simulates user input events by generating system level events 306. For example, interactivity testing code 204 on a follower browser machine may receive a record 214 describing a user interaction the leader browser, and then generate a system level event to cause a corresponding interaction with a pertinent follower element. In some embodiments, an event handler “simulates” events by capturing and responding to them.

In some embodiments, an event handler 304 is inserted in a page 128 in a browser using familiar DOM hooks. In some embodiments, an event handler 304 is inserted in a rewritten web page 128, that is, the HTML is modified by the testing code 204 to insert the event handler. In either case, the inserted event handler is normally not present in an original version of the web page 128 on a web server 142, and the event handler is configured to handle events caused by user input device signals.

In other words, the inserted event handler intercepts an event that would otherwise have gone to a different event handler, or would have gone nowhere (some events have no listeners). In the leader browser, the page can be rewritten such that any element having an event handler Z also has the inserted handler 304 prepended to that event handler Z. The inserted handler 304 sends a message to interactivity testing code 204 that the event was triggered, and then passes the event through to the original event handler Z. The interactivity testing code 204 simulates the same event in the follower browsers. Event handler insertion can be done without rewriting the web page; HTML DOM provides familiar mechanisms for hooking up event handlers without actually re-writing the source HTML.

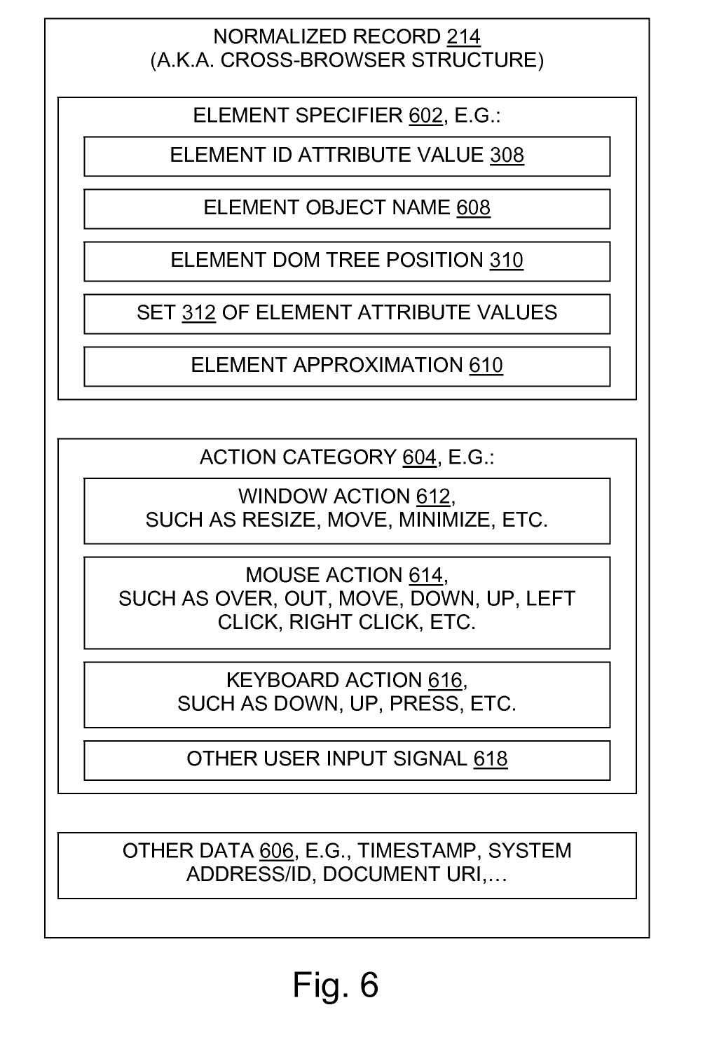

With particular reference to FIGS. 3 and 6, in some embodiments, a normalized record 214 of user interaction with the leader browser 202 is used. The normalized record resides in at least one local memory; a record 214 may be used to guide a follower browser on the same machine as the leader browser and/or may be transmitted over a network to a follower browser on a remote machine. The normalized record includes an element specifier 602, an action category 604, and optionally includes other data 606 such as a timestamp, an address of other identifier of the leader browser system, a URI or other address of the web page document that is loaded in the leader browser, a checksum, and/or a digital signature, for example.

The element specifier 602 specifies pertinent elements. For instance, a pertinent element may be specified by an element ID attribute value 308, by an object name 608, by a DOM tree position 310, or by a set 312 of attribute values. In some cases, a pertinent element may not be specified as precisely and concisely as can be done with the foregoing, but can nonetheless be at least approximately specified. An element approximation 610 may be formed, for instance, as a best guess based on mouse coordinates and the distance to a center point of a display region whose width and height are known. Similarly, a rendered page can be partitioned into tiles according to DOM element display regions, and mouse coordinates can be used to approximately identify a pertinent element.

The action category 604 specifies user input device signal categories. Input may be treated as a window action 612, a mouse action 614, a keyboard action 616, or another kind of action signal 618, for instance.

Window actions 612 pertain to user actions on a browser interface window, such as actions to move the window's position on screen, to resize the window on screen, to minimize the window into a system tray, to maximize the window's area on screen, and so on.

Mouse actions 614 may pertain to user actions made with a mouse, pen, touch-screen, or similar input device. Alternately, mouse actions 614 may pertain only to actions taken with a mouse, and the other input devices may be handled using other categories 604, or may be ignored. Unless otherwise indicated, mouse actions pertain to actions taken with a mouse and/or with any other pointing device (pen, touch-screen, track ball, touch pad, etc.). In some embodiments, possible mouse actions include one or more of the following: Mouse over (when the mouse initially enters an element's screen territory, e.g., when a mouse-driven cursor 404 initially enters a screen region 406); Mouse out (when the mouse leaves an element's territory); Mouse move (when the mouse moves within an element's territory); Mouse down (a mouse button is pressed over an element's territory); Mouse up (a mouse button is released over an element's territory); Mouse click (when a mouse down+mouse up combination occurs over the same location); Mouse double-click. Some embodiments implement only some of the foregoing Mouse actions, and some implement other mouse/pointing device actions.

Keyboard actions 616 pertain to user actions made with a mechanical or virtual (on-screen) keyboard. In some embodiments, possible keyboard actions include one or more of the following: key down, key up, key press (rapid down−up combination).

In some embodiments, a cross-browser structure includes one or more normalized records 214, each having an element ID attribute value 308 of the pertinent element 208 and an action category 604 value which corresponds with at least one of the following mouse actions 614: mouse-click, mouse-over, keyboard. In some embodiments, a cross-browser structure includes one or more normalized records 214, each having an object name 608 of the pertinent element 208, a DOM tree position 310 of the pertinent element 208, and an action category 604 value which corresponds with at least one of the following: mouse-click, mouse-over, keyboard action 616. Of course, other variations based on the description herein are also possible.

Methods

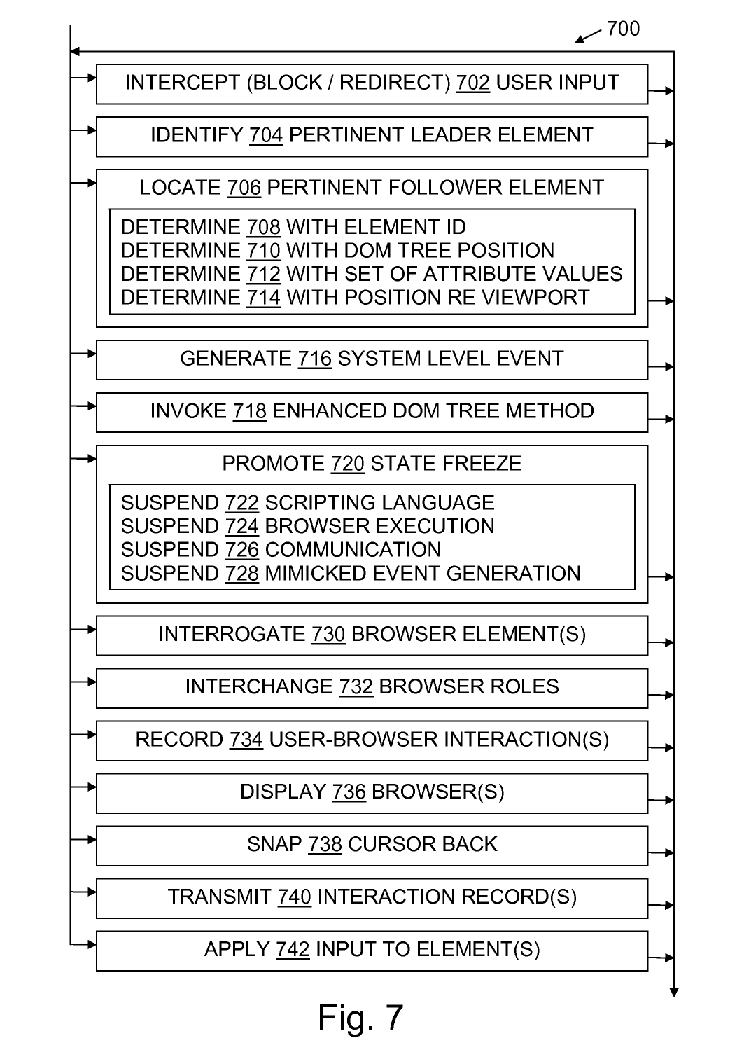

FIG. 7 illustrates some method embodiments in a flowchart 700. Methods shown in the Figures may be performed in some embodiments automatically, e.g., by a leader browser 202 and interactivity testing code 204 playing back a sequence of normalized records 214 requiring little or no contemporaneous (live) user input. Methods may also be performed in part automatically and in part manually unless otherwise indicated. Particular steps may be done automatically, regardless of which steps are specifically described as automatic. In a given embodiment zero or more illustrated steps of a method may be repeated, perhaps with different parameters or data to operate on. Steps in an embodiment may also be done in a different order than the top-to-bottom order that is laid out in FIG. 7. Steps may be performed serially, in a partially overlapping manner, or fully in parallel. The order in which flowchart 700 is traversed to indicate the steps performed during a method may vary from one performance of the method to another performance of the method. The flowchart traversal order may also vary from one method embodiment to another method embodiment. Steps may also be omitted, combined, renamed, regrouped, or otherwise depart from the illustrated flow, provided that the method performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

During an intercepting step 702, an embodiment blocks, redirects, or otherwise intercepts a user input 120. Step 702 may be accomplished using a transparent window 302, inserted event handler(s) 304, and/or other mechanism, for example.

During an identifying step 704, an embodiment identifies a pertinent leader element 208, namely, the element to which a user input is directed. Step 704 may be accomplished in various ways. For example, a mouse action screen position may be matched with element screen regions to identity a target element. As another example, an event handler may be inserted to intercept events, in effect letting an original event handler determine which element is targeted, and then tapping into that determination to identify the pertinent element. As another example, a DOM tree 132 may be made into an enhanced DOM tree 314 by inserting method(s) 316 onto elements, the inserted method(s) being configured to raise an event, send a message, or otherwise notify interactivity testing code when the element in question receives input.

During a locating step 706, an embodiment locates a pertinent follower element 210, namely, the element corresponding to the pertinent leader element 208. Step 706 may be accomplished using various determinations 708-714. For example, during element ID determining step 708, usable if the pertinent leader element has an ID attribute value 308 which distinguishes it from other elements of the page 128 in question, step 706 can be done by finding (e.g., by indexed access, or tree traversal) the element in the follower browser that has the same ID attribute value. Otherwise, during tree position determining step 710, the pertinent leader element's position 310 in the DOM tree can be used, e.g., in the form of an ordinal element encountered during a specified traversal of the DOM tree, or as the destination element reached by a specified path taken from the root which indicates which tree link to follow at each intervening element. During a determining step 712, an identifying set 312 of attribute values is used to test each possible element in the follower DOM tree until the pertinent follower element (the element with the same set 312 of values) is located. During a view position determining step 714, an element approximation 610 based on position relative to a viewport can also be used in some embodiments, e.g., by making a guess based on mouse coordinates and screen regions, or by tiling the page into screen regions by DOM element.

During an event generating step 716, an embodiment generates a system level event, encapsulating actions such as a window action 612, a mouse action 614, or a keyboard action 616. Unlike familiar system level events, generated system level events occur in response to a normalized record 214 or other communication from leader browser interactivity testing code, not from user input directed at an isolated browser. However, the same event data formats can be used in generated 716 system level events as in familiar system level events.

During an invoking step 718, an embodiment invokes an inserted method 316 defined in an enhanced DOM tree 314, to update interactivity testing code 204 about the circumstances or content of an element 130 to which the invoked method is attached. Familiar method invocation mechanisms can be used. Note that some embodiments capture an event and the element associated with the event. In order to play the event back to the same element in the follower browser, some embodiments simulate a system event at the location of the element in the follower browser. An enhanced DOM is not necessarily used in every embodiment. Some embodiments simulate an event through the browser (instead of the system), so an enhanced DOM tree is not required; instead the embodiment traverses the tree and plays the event to the pertinent object.

During a freeze-promoting step 720, a.k.a. freezing step 720, an embodiment freezes or assists in freezing the state of DOM element(s) 130 in a browser 202/206. For instance, step 720 may include suspending 722 execution of JavaScript® code, Cascading Style Sheet code, or another scripting language 216. Step 720 may include suspending 724 browser 202/206 execution, using breakpoints or HALT instructions, for instance. Step 720 may include suspending 726 communication between a browser 202/206 or browser 202/206 device and a web server 142, e.g., by halting AJAX (asynchronous JavaScript® and XML) and other processes that communicate using XML, HTML, HTTP, TCP/IP, and/or other familiar formats and protocols. Step 720 may include suspending 728 generation 716 of system level events to mimic direct user input to a follower browser.

During an interrogating step 730, an embodiment interrogates an element 130 regarding its position, styling, attribute presence(s), attribute value(s), and/or other characteristics. Familiar mechanisms for interrogating element(s) can be used. Some embodiments allow (and some require) a developer to freeze 720 a browser before interrogating element(s) in that browser. After interrogation, suspended operations can be resumed to continue interactivity testing with additional input to the leader browser.

During an interchanging step 732, some embodiments interchange the roles of a leader browser and a specified follower browser, so the follower becomes the new leader and the old leader becomes a follower. Step 732 may include, for instance, updating or putting in place mechanism(s) 212 to block direct user input to the follower and to intercept the new leader's events and send them to interactivity testing code 204 to be encapsulated in normalized records 214 which are sent to the new follower to provoke generation 716 of system level events in the follower. Step 732 may be done automatically when a designated cursor 404 leaves the leader's display region 402 and enters the follower's display region. Menu options or other familiar selection mechanisms may also be used to indicate that roles should be interchanged.

During a recording step 734, an embodiment records user-browser interactions, e.g., by storing one or more normalized records 214 in a medium 112.

During a displaying step 736, an embodiment displays one or more browsers. In some embodiments, a leader browser 202 and a follower browser 206 are displayed together on a single screen, as illustrated in FIG. 4. In some embodiments, a leader browser is displayed on one device and at least one follower browser is displayed on a different device. FIG. 5, for instance, shows a configuration in which browsers are displayed on four devices. Step 736 may be done using familiar user interface mechanisms.

During a snapping step 738, an embodiment snaps a cursor 404 to screen position(s) corresponding to targeted element(s). Consider software that merely records mouse movements and keyboard input, without relating those user inputs to DOM elements as described herein. If the recorded inputs were replayed into a different browser whose elements have somewhat different screen regions because of differences in layout engines, for instance, then different elements could well receive the input during playback than during the recording. With embodiments described herein, by contrast, the same elements can receive the input events. During playback, a visual indication that inputs are being handled on a per-element basis may be that the cursor snaps (jumps/moves discontinuously) from element region to element region rather than moving continuously as it would in a video recording. In some embodiments, the snapping step 738 is an optional step when playing back activity into follower browser(s).

During a transmitting step 740, normalized records 214 are transmitted over a network to follower browser(s). In some embodiments, the transmitting step 740 is performed when playing back activity into remote follower browser(s).

During an applying step 742, user input is applied to element(s). For instance, a user input 120 may be applied to an element in a leader browser by allowing the browser to create a system level event as it typically would in the absence of interactivity testing code 204 except that a normalized record 214 of the input is made for use by follower browser(s). The same user input 120 may then be applied to an element in a follower browser by generating 716 a system level event based on the normalized record 214. Applying step 742 does not necessarily require that one apply the user input to the leader browser; one could simply intercept the input event and let it funnel through. That is, one does not necessarily actively apply the user input but may instead passively apply the input.

The foregoing steps and their interrelationships are discussed in greater detail below, in connection with various embodiments.

Some embodiments provide a multi-browser interactivity testing process utilizing at least one device which has at least one display, at least one logical processor, and at least one memory in operable communication with a logical processor and a display. The process includes intercepting 702 a user input 120 to a leader browser 202. The process also includes identifying 704 a pertinent leader element 208, namely, a Document Object Model element 130 in the leader browser which is configured to respond to the intercepted user input. The process also includes locating 706 a pertinent follower element 210, namely, a Document Object Model element in a follower browser 206 which corresponds to the pertinent leader element. The process also includes applying 742 the user input to the pertinent leader element, and applying 742 the user input to the pertinent follower element. In some embodiments, the process includes locating 706 pertinent follower elements in multiple follower browsers, and applying 742 the user input in at least one of those follower browsers.

In some embodiments, the step of locating 706 a pertinent follower element includes at least one of the following: determining 708 that the follower element has an identifying element ID attribute value that also identifies the pertinent leader element; determining 710 that the follower element has an identifying DOM tree position that also identifies the pertinent leader element; determining 712 that the follower element has a set of element attribute values that also identifies the pertinent leader element; determining 712, 714 that the follower element has a combination of element attribute values and a position with respect to viewport origin that also identifies the pertinent leader element. In some embodiments, a dynamically determined set of element attribute values is used; the attribute values of elements in the DOM tree are examined and a set of values which belongs only to the pertinent leader element is found and used. In some embodiments, a predetermined set of element attribute values is used, based on the assumption that this set will always distinguish any leader element 130 from the other leader elements. In some situations, however, a set of element attribute values will match multiple elements, one of which will then be chosen, e.g., by default or by user selection. In some embodiments, the same document is loaded in multiple browsers, and the browsers are sized to the same pixel dimensions.

In some embodiments, the step of applying 742 the user input to the pertinent follower element includes generating 716 a system level event in the follower browser despite the absence of direct user input to the follower browser. Such generated events mimic (simulate) direct user input, by replicating at the element 130 level the user input that was given directly to the leader browser.

In some embodiments, the step of applying 742 the user input to the pertinent follower element includes invoking on the pertinent follower element a method 316 defined in an enhanced DOM tree. Such methods 316 may also be referred to as methods defined by the DOM. Methods 316 include, but are not necessarily limited, scripting language methods (e.g., in Sun Microsystems JavaScript® code, Adobe ActionScript® code, Microsoft VBScript™ code), and methods in other programming languages such as C# or C++, for example. The DOM defines methods that the elements 130 of the DOM expose, and these methods can be called from scripting languages 216 and other languages.

In some embodiments, the process includes promoting 720 a state freeze by performing at least one of the following: suspending 722 a scripting language in the leader browser (e.g., turn off JavaScript® machine); suspending 722 a scripting language in the follower browser; suspending 724 execution of a browser; suspending 726 communication between the leader browser and a web server (e.g., turn off AJAX); suspending 726 communication between the follower browser and a web server; suspending 728 generation of mimicked system level events in the follower browser, namely, events which simulate but are not caused by direct user input to the follower browser.

In some embodiments, the process includes interrogating 730 a browser about a browser element's position and/or styling by reading attribute values. In some embodiments, interrogation 730 happens during a frozen state. Otherwise, the DOM could be changing while the interrogation is happening, which could make readings unreliable. Information obtained by interrogation 730 can be displayed to the user and/or recorded it for possible later examination is another possibility. In some embodiments, interrogation occurs automatically without requiring a frozen state, e.g., a breakpoint could be based on interrogation: “stop when element X style becomes S1”.

Some embodiments include interchanging 732 browser roles such that the leader browser becomes a follower browser, and the follower browser becomes a leader browser, and then repeating the identifying 704, locating 706, and applying 742 steps with the browser roles interchanged.

Some embodiments include recording 734 interactions between a user and the leader browser. The recorded interactions can then be played back in one or more browsers; playback may be simultaneous or sequential if it occurs in multiple browsers.

Some embodiments are implemented in a computer-readable storage medium configured with data and with instructions that when executed by at least one processor causes the at least one processor to perform a process for assisting multi-browser interactivity testing. The process includes identifying 704 a pertinent leader element, namely, a Document Object Model element in a leader browser which is configured to respond to a user input; locating 706 a pertinent follower element, namely, a Document Object Model element in a follower browser which corresponds to the pertinent leader element; applying 742 the user input to the pertinent follower element; and interrogating 730 at least one of: the pertinent leader element, the pertinent follower element, thereby obtaining at least one of: position information, styling information.

In some embodiments, the process further includes blocking (a type of intercepting 702) the follower browser from receiving direct user input.

In some embodiments, the process further includes displaying 736 the leader browser and the follower browser on a single device while applying 742 the user input to the pertinent follower element. FIG. 4 illustrates one such possible embodiment.

In some embodiments, the process further includes transmitting 740 toward the follower browser a normalized record 214 of user interaction with the leader browser.

In some embodiments, the process further includes rewriting HTML of a document that is displayed in the follower browser, the rewriting (a form of intercepting 702) corresponding to user interaction with the leader browser.

In some embodiments, the process further includes simulating user input events in the follower browser by generating 716 events, e.g., sending a click to element X. Some embodiments use page rewritten to insert JavaScript® code to hook up event handlers 304 as simulators. Some embodiments avoid rewriting but instead use methods/events exposed via the DOM.

In some embodiments, the process includes snapping 738 a display cursor back to a pre-interrogation screen position after the interrogating step. The actual cursor driven directly by a mouse is in the leader browser; some embodiments simulate a cursor in the follower browsers. Depending on the implementation, the follower cursor(s) do not necessarily track every movement of the leader cursor. For instance, interactivity testing code may ignore movements within an element's region 406 and simply have the cursor jump from element region to element region. In fact, since the same element 130 may layout differently in different browsers, the follower cursors may well jump between element regions during interactivity testing. In some embodiments, the leader browser's cursor always tracks the mouse. A follower browser's cursor may only move from element to element, or at least not completely track all mouse movements within an element.

In some embodiments, the process further includes automatically interchanging 732 browser roles such that a current leader browser becomes a follower browser, and the follower browser becomes a new leader browser, in response to a user input outside a screen region allocated to the current leader browser. The user input outside a screen region allocated to the current leader browser can be either a special keyboard command, or a mouse/pen/touch screen hit outside the current leader browser's window, for example.

Configured Media

Some embodiments include a configured computer-readable storage medium 112. Medium 112 may include disks (magnetic, optical, or otherwise), RAM, EEPROMS or other ROMs, and/or other configurable memory, including in particular non-transitory computer-readable media (as opposed to wires and other propagated signal media). The storage medium which is configured may be in particular a removable storage medium 114 such as a CD, DVD, or flash memory. A general-purpose memory, which may be removable or not, and may be volatile or not, can be configured into an embodiment using items such as interactivity testing code 204, mechanism(s) 212, and/or normalized records 214, in the form of data 118 and instructions 116, read from a removable medium 114 and/or another source such as a network connection, to form a configured medium. The configured medium 112 is capable of causing a computer system to perform method steps for transforming data through interactivity testing as disclosed herein. FIGS. 1 through 7 thus help illustrate configured storage media embodiments and method embodiments, as well as system and method embodiments. In particular, any of the method steps illustrated in FIG. 7, or otherwise taught herein, may be used to help configure a storage medium to form a configured medium embodiment.

### ADDITIONAL EXAMPLES

Additional details and design considerations are provided below. As with the other examples herein, the features described may be used individually and/or in combination, or not at all, in a given embodiment.

On an HTML page 128, all the individual page elements 130 are organized in a tree hierarchy known as the document object model (DOM). Every DOM element 130 can listen-to and react-to user-initiated actions via an event mechanism. The DOM hierarchy can vary from browser to browser, and even from browser version to browser version. Using teachings herein, for a given page the browser DOMs can be normalized so the hierarchies can be treated identically. Embodiments provide mechanisms for re-applying normalized tree element messages (e.g., records 214) across a range of browsers. Embodiments allow developers to view interaction created in one browser as it is replicated at the DOM element level across a range of other supported browsers. Unlike solutions to cross-browser diagnostics and debugging that focus solely on page layout, embodiments described herein allow interactivity testing.

In some embodiments, a user can work with a page display in a leader browser and in an arbitrary number of follower browsers. Results of user initiated actions taken in the leader browser (e.g., clicks, mouse-overs, drag events) are displayed in near-real-time in the follower browsers. Some embodiments operate by intercepting 702 events on DOM objects and then replaying those events on the identical page elements in the other browsers. This allows the user to evaluate whether the page's interactive behavior operates identically from browser to browser. Because of browser rendering differences, DOM elements will sometimes not be located in the same physical (x, y) screen position across leader and follower browsers. Thus, embodiments do not simply simulate a system event at a given location within a window, but instead locate 706 the affected element in follower browser DOMs and apply the operation to that element.

Some embodiments provide a mechanism for generating and recording page interactions described both as operations against mark-up elements as well as application-level messages (e.g., explicit mouse coordinates). Some embodiments provide a mechanism for raising/lowering system messages (such as a mouse movement at a specific screen coordinate) to and from an element in the DOM tree (such as a hover over an <Ii> tag).

In some embodiments, follower browsers can be located on the same physical machine as the master, or on different machines communicating across a local network or the Internet. Some embodiments include an interactivity testing code 204 interface that hosts multiple browsers on the same machine and allows them to be easily compared and viewed together.

In some embodiments, interactivity can be frozen at any point for comparing layouts across browsers. An interface for seeing what operations are being applied and have been applied to which elements can be utilized, based on familiar or innovative mechanisms. Some tools provide cross-browser debugging and diagnostics for identifying page layout problems across multiple browsers. Embodiments described herein address additional aspects.

One aspect concerns how one can test the layout of web pages that require some interactivity to get into a particular state. For example, a web page 128 that is behind a log-in screen needs to have that log-in information filled in and submitted before the page layout of interest can be analyzed. To compare the page in multiple browsers, each browser (leader and follower(s)) receives the same log-in information and submits it to a server at (nearly) the same time. As another example, in the case of comparing content that is hidden behind a so-called “accordion control” the accordion control should be triggered before the content layout is compared. Embodiments described herein allow the accordion control to be triggered so the layouts in all the browsers of interest can be compared.

Another aspect concerns how one can test interactivity across multiple browsers. Increasingly, web pages 128 are incorporating interactive elements such as menus, tree controls, overlay controls, photo galleries, etc. Because the HTML/CSS and JavaScript® machine implementations vary across different browsers, developers can benefit from testing this interactivity simultaneously across multiple browsers to ensure that it works correctly.

Some familiar approaches help a web page author debug cross-browser layout issues by taking a picture of a web page as rendered in multiple browsers and then providing a set of tools to help compare these pictures and the elements used to create them. By contrast, some embodiments described herein link multiple live browsers, thereby allowing interactivity to be comprehensively compared across these browsers.

In some embodiments, the browsers are hosted in a common interface which allows a user to easily select the browsers to be compared. In the case of the two browsers shown in FIG. 4, the browser on the left is the “baseline” or leader browser and the right browser is the follower. Some embodiments allow multiple follower browsers.

Suppose a web page has a set of pop-up menus that become visible when the user moves the cursor over a word in the navigation strip. An HTML document is composed of a series of elements 130 that populate a tree-style hierarchy known as the Document Object Model (DOM). Each type of element has a variety of events it can respond to, such as mouse-over, click, double-click, focus, etc. The events can also propagate upwards from child elements to their parents. Some embodiments block follower browsers from receiving any system level messages regarding direct window input, so the follower(s) won't react to any direct clicks or mouse movements in their respective window(s). Within the leader browser window, mouse and keyboard events are intercepted. For mouse events, the position of the cursor is tracked, and the element 130 beneath the cursor is associated with each mouse event, e.g., in a normalized record 214. In the case of keyboard events, the element with focus is associated with each key input. In one example, a mouse over event occurs when the user moves their cursor over the words “About Me” in the navigation strip.

Once the event and associated element have been retrieved or otherwise identified, they will be applied to the follower browser(s). Messages associated with the leader window (and not with page elements), such as move and resize, are applied to the follower browser's window in the form of system messages. Events that are applied to page elements in the leader browser are applied to the corresponding page element in the follower browsers. The display (screen and/or viewport) location of the corresponding element in the follower browsers may not match the location of the element in the leader browser, so the location of the element involved is found. Since the DOM trees may not be identical between leader and follower browsers, the target page element is algorithmically identified in the leader browser and located in the follower browsers. Once the element is found, the event is programmatically applied to the element. When an event is replayed to the corresponding element in the follower browsers, they will demonstrate the same behavior as the leader, if the page is compatible across different browsers, or different behavior if the page is not compatible.

In some cases a user may want to test/examine the layout of elements at a particular interactive state, such as when a menu is extended. In this case, some embodiments can freeze the interactivity. In one example, hitting the F11 key will freeze the state of the leader and follower browsers. At this point the user can interrogate 730 the browsers for the position and styling information for each element to determine what the source of any discrepancy might be. Hitting F11 again will unfreeze the interactivity, allowing the user to trigger events in the browsers once more.

Embodiments are not limited to browsers installed on a single machine. The teachings herein can be used to control a browser on a network-connected device. This could be used to test compatibility between browsers on Apple® Macintosh® and Microsoft® Windows machines, for example. In the case of a non-local browser, some embodiments use an interactivity testing utility that receives messages from the leader browser and applies them to the remote follower.

It may also be useful to display and/or record the sequence of events and elements they are applied to. This could be used to help debug pages or to replay a sequence at a different point in time.

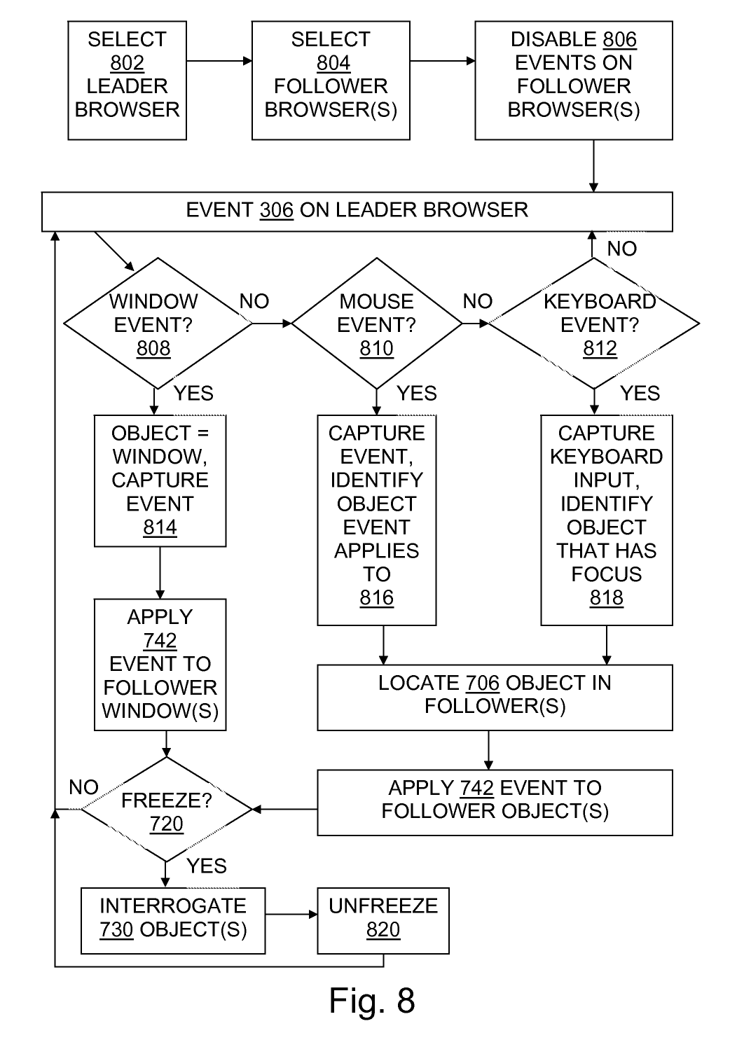

FIG. 8 shows another view of some embodiments. A developer selects 802 a leader browser 202 and selects 804 one or more follower browsers 206. Interactivity testing code disables 806 events on the follower browsers, e.g., by blocking or otherwise intercepting 702 direct user input after installing mechanisms 212. An event 306 occurs on the leader browser, and the interactivity testing code 204 determines whether the event is a window event 808, a mouse event 810, or a keyboard event 812. A window event is captured 814 and the window object is noted, e.g., in a normalized record 214. Then the event is applied 742 to the follower browser(s) respective window(s). A mouse event is likewise captured 816 and the object (element) that the mouse event targets is identified 704. A keyboard event is likewise captured 818 and the object (element) that the keyboard event targets is identified 704. After identification 704 of an object in the leader, the corresponding object is located 706 in the follower(s), and the event is applied 742 to the follower object(s). A developer may freeze 720 the state of the browser(s). Selected object(s) can be interrogated 730, before unfreezing 820 the browser(s) and continuing interaction with the objects via direct input to the leader browser and simulated matching interaction in the follower browser(s).

Conclusion

Although particular embodiments are expressly illustrated and described herein as methods, as configured media, or as systems, it will be appreciated that discussion of one type of embodiment also generally extends to other embodiment types. For instance, the descriptions of methods in connection with FIGS. 7 and 8 also help describe configured media, and help describe the operation of systems and manufactures like those discussed in connection with other Figures. It does not follow that limitations from one embodiment are necessarily read into another. In particular, methods are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

As used herein, “configured to respond to the intercepted user input” and similar language does not necessarily require that a response occur. An element can be “configured to respond to user input” merely by virtue of being an intended target of user input. Thus, an element configured to respond to user input need not have an event handler registered for some user event. An embodiment may intercept an event even if the target element (the element configured to respond to the input) isn't actually going to do anything in response to the event. For example, mousing over a DIV in one browser may do nothing, whereas the same DIV in another browser has a mouse over that changes its background color. An embodiment may still intercept the event in the leader browser even if the follower browser isn't going to take an action in response to the event.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or methodological acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A multi-browser interactivity testing process utilizing at least one device which has at least one display, at least one logical processor, and at least one memory in operable communication with a logical processor and a display, the process comprising the steps of:
intercepting a user input to a leader browser;
identifying a pertinent leader element, namely, a Document Object Model element in the leader browser which is configured to respond to the intercepted user input;
locating a pertinent follower element, namely, a Document Object Model element in a follower browser which corresponds to the pertinent leader element;
applying the user input to the pertinent leader element; and
applying the user input to the pertinent follower element.

2. The process of claim 1, wherein the step of locating a pertinent follower element comprises at least one of the following:
determining that the follower element has an identifying element ID attribute value that also identifies the pertinent leader element;
determining that the follower element has an identifying DOM tree position that also identifies the pertinent leader element;
determining that the follower element has a set of element attribute values that also identifies the pertinent leader element;
determining that the follower element has a combination of element attribute values and a position with respect to viewport origin that also identifies the pertinent leader element.

3. The process of claim 1, wherein the step of applying the user input to the pertinent follower element comprises at least one of the following:
generating a system level event in the follower browser despite the absence of direct user input to the follower browser;
invoking on the pertinent follower element a method defined in an enhanced DOM tree.

4. The process of claim 1, further comprising promoting a state freeze by performing at least one of the following:
suspending a scripting language in the leader browser;
suspending a scripting language in the follower browser;
suspending execution of a browser;
suspending communication between the leader browser and a web server;
suspending communication between the follower browser and a web server;
suspending generation of mimicked system level events in the follower browser, namely, events which simulate but are not caused by direct user input to the follower browser.

5. The process of claim 1, further comprising interrogating a browser about a browser element's position and/or styling.

6. The process of claim 1, further comprising:
interchanging browser roles such that the leader browser becomes a follower browser, and the follower browser becomes a leader browser; and then
repeating the identifying, locating, and applying steps with the browser roles interchanged.

7. The process of claim 1, further comprising recording interactions between a user and the leader browser.

8. A multi-browser interactivity testing system comprising:
at least one logical processor;
at least one local memory in operable communication with a logical processor;
a leader browser having leader Document Object Model elements residing in a local memory;
a follower browser having follower Document Object Model elements residing in a local memory; and
interactivity testing code residing in at least one local memory, the interactivity testing code (i) configured to locate, among the follower Document Object Model elements, a pertinent follower element which corresponds to a pertinent leader element, the pertinent leader element being a leader Document Object Model element targeted by a user input to the leader browser, and (ii) configured to apply the user input to the pertinent follower element.

9. The system of claim 8, wherein the leader browser, the follower browser, and the interactivity testing code all reside on the same device.

10. The system of claim 8, wherein the leader browser resides on a first device having a first logical processor and a first local memory, the follower browser resides on a second device having a second logical processor and a second local memory, and at least a portion of the interactivity testing code resides on each of the devices.

11. The system of claim 10, wherein:
device categories comprise workstation devices, portable devices, embedded devices, and phone devices;
the first device and the second device are of different device categories; and
interactivity testing code is not necessarily implemented in every device categories.

12. The system of claim 8, further comprising at least one additional pertinent follower element in at least one additional follower browser, and wherein the interactivity testing code is configured to applying the user input to at least one of the additional pertinent follower element(s).

13. The system of claim 8, further comprising at least one of the following:
a transparent window positioned in front of a browser window, allowing the interactivity testing code to intercept a user input device signal directed at the browser;
a hook on a window handler for a browser;
an event handler which simulates (captures and responds to) user input events;
an event handler inserted in a rewritten web page, the event handler not present in an original version of the web page on a web server, the event handler configured to handle events caused by user input device signals.

14. The system of claim 8, further comprising a normalized record of user interaction with the leader browser, the normalized record residing in at least one local memory.

15. A computer-readable non-transitory storage medium configured with data and with instructions that when executed by at least one processor causes the at least one processor to perform a process for assisting multi-browser interactivity testing, the process comprising the steps of:
identifying a pertinent leader element, namely, a Document Object Model element in a leader browser which is configured to respond to a user input;
locating a pertinent follower element, namely, a Document Object Model element in a follower browser which corresponds to the pertinent leader element;
applying the user input to the pertinent follower element; and
interrogating at least one of: the pertinent leader element, the pertinent follower element, thereby obtaining at least one of: position information, styling information.

16. The configured medium of claim 15, wherein the process further comprises blocking the follower browser from receiving direct user input.

17. The configured medium of claim 15, wherein the process further comprises displaying the leader browser and the follower browser on a single device while applying the user input to the pertinent follower element.

18. The configured medium of claim 15, wherein the process further comprises at least one of:
transmitting toward the follower browser a normalized record of user interaction with the leader browser;
rewriting HTML of a document that is displayed in the follower browser, the rewriting corresponding to user interaction with the leader browser;
simulating user input events in the follower browser.

19. The configured medium of claim 15, wherein the process further comprises snapping a display cursor back to a pre-interrogation screen position after the interrogating step.

20. The configured medium of claim 15, wherein the process further comprises automatically interchanging browser roles such that a current leader browser becomes a follower browser, and the follower browser becomes a new leader browser, in response to a user input outside a screen region allocated to the current leader browser.
